(19) United States
(12) Patent Application Publication
(10) Pub. No.: US 2002/0100720 A1
(43) Pub. Date: Aug. 1, 2002

(54) Filter arrangement for liquids

(76) Inventor: Herbert Jainek, Heilbronn (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/024,570

(22) Filed: Dec. 21, 2001

(30) Foreign Application Priority Data
Dec. 22, 2000 (DE) 100 64 482.1

(51) Int. Cl. B01D 35/16

(52) U.S. Cl. 210/248; 210/440; 210/450

(57) ABSTRACT

A filter arrangement for liquids including a filter element (6) that can be axially inserted into a filter housing (4) during assembly of the filter arrangement (1). After installation, this filter element (6) seals a back flow device at least for the liquid to be filtered with at least one seal (12) in front of a return flow channel (16). The device is configured in such a way that as the filter element (6) is axially withdrawn, a first seal (12 ; 20; 30; 40) can be initially released to enable return flow of unfiltered liquid, and as the filter element (6) continues to be axially withdrawn, a second seal (18; 22; 41) can be released to enable return flow of filtered liquid.

### BACKGROUND OF THE INVENTION

The present invention relates to a filter arrangement for liquids, particularly for oil or fuel in an internal combustion engine.

It is known in the art to use a metal-free filter element in an oil filter to clean the oil of an internal combustion engine. This filter element is inserted into a housing and the housing is sealed by a cover. To reduce oil back flow when the internal combustion engine is shut down, an anti-back flow valve is normally provided in the housing. This anti-back flow valve must be installed in the housing in a separate mounting step. It typically comprises a valve disk biased by a spring, a valve crown and a valve seat. The valve is screwed or inserted into the housing. A drawback, in general, is that this component is time-consuming and expensive to mount.

German Patent No. DE 42 40 656 C2, for instance, discloses a filter arrangement for fuel and/or lubricants of an internal combustion engine, comprising a bottom drain that is sealed by an end disk of the filter element when the filter element is inserted. This drain is opened as soon as the filter element is removed, so that the oil can flow out through this outlet channel into a collecting pan. This prior art also discloses an anti-back flow valve, which consists of a metal plate biased by a spring and seals the unfiltered oil inlet channel. For this purpose, various valve components are required.

### SUMMARY OF THE INVENTION

It is the object of the invention to provide an improve filter arrangement in which oil contained in the filter is drained away in a controlled manner when the filter cartridge is removed for replacement.

Another object of the invention is to provide a filter arrangement with a simple construction which permits simple opening and blocking of the back flow of the liquid in the filter arrangement, particularly when the filter arrangement is serviced by replacing the filter element.

A still further object of the invention is to provide a filter arrangement which prevents cross contamination of filtered oil with unfiltered oil when the filter cartridge is removed for replacement without requiring complex structural arrangements.

These and other objects are achieved in accordance with the present invention by providing a filter arrangement for liquids comprising a filter element which during installation of the filter arrangement can be axially inserted into a filter housing, wherein after installation the filter element seals a back flow device at least for the liquid to be filtered with at least one seal in front of the back flow channel, wherein the back flow device is configured in such a way that as the filter element is being axially pulled out, a first seal is initially released for the back flow of the liquid to be filtered, and as the filter element continues to be axially pulled out, a second seal is released for the back flow of the filtered liquid.

The initially described filter arrangement for liquids, particularly fuel and/or lubricants for an internal combustion engine in a motor vehicle, having a filter element that is axially inserted into a filter housing when the filter element is installed, is configured in such a way that the filter, once installed, seals an anti-back flow device at least for the liquid to be filtered with at least one seal in front of the back flow channel. According to the invention, this anti-back flow device is advantageously configured in such a way that as the filter element is being axially pulled out, a first seal is initially released for return flow of the liquid to be filtered. As the filter element continues to be axially pulled out, a second seal is released for return flow of the filtered liquid.

If the filter arrangement has a cylindrical construction, the seals according to the invention are generally sealing disks or sealing rings, which in principle form a simple anti-back flow valve in conjunction with parts of the inner wall of the housing. These sealing disks or rings are permanently connected with the filter element, so that they are replaced together with the filter element when regular maintenance service is carried out. This has the advantage that the aging behavior of the anti-back flow valve according to the invention is negligible.

The first seal is preferably mounted to the filter element in such a way that it fits sealingly against a housing wall within a predefined axial range of motion. The second seal is advantageously arranged on the filter element in such a way that it also fits sealingly against an axially extending housing wall within a predefined axial range of motion. This range of motion for the second seal, however, is longer than that of the first seal.

This assures that initially the unfiltered fluid, e.g., the unfiltered oil, and subsequently the filtered fluid, e.g., the filtered oil, can be discharged successively.

In such a case, the typically radial surfaces of the second seal fit against a standpipe of the filter arrangement and through this contact with the center tube form the seal between the unfiltered liquid side and the filtered liquid side. The standpipe prevents the oil level within the filter from decreasing after engine shutdown as a function of the height of the standpipe if there is leakage in the layers of the filter element on the filtered side. In addition, the filter arrangement may also comprise a pressure relief valve, which opens a bypass if the differential pressure between the unfiltered oil side and the filtered oil side increases above a desired maximum level.

In accordance with a first advantageous embodiment, the first range of motion is formed by an axial extension against which the first seal rests inside the housing between the inlet for the liquid to be filtered and the return channel.

In accordance with a second embodiment, the first range of motion is formed by an axially extending first seal that rests against an axially extending extension within the housing between the inlet for the liquid to be filtered and the return flow channel.

Further, according to a third embodiment, it is advantageous if the first range of motion is formed by a seal located axially between the filter element and the bottom of the housing. This seal also extends radially to the axially extending housing wall to define the second range of motion.

Alternatively, the synthetic resin component carrying the first seal can also extend radially outwardly beyond the edge of the filter element, so that a membrane surface is formed in the inlet for the liquid to be filtered. This membrane surface, in conjunction with a radial or axial limit stop on the housing, partly blocks the back flow of the liquid to be filtered in the manner of an anti-back flow valve. According to the invention, two valve functions can thus be combined, i.e., an anti-back flow valve with a membrane on a plastic support and an anti-drain valve on the same plastic support.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments depicted in the accompanying drawings in which:

FIG. 1 is a sectional view of a first illustrative embodiment of an oil filter arrangement with a membrane seal;

FIG. 2 is a sectional view of an illustrative embodiment of an oil filter arrangement with two annular seals;

FIG. 3 is a sectional view of a modification of the illustrative embodiment shown in FIG. 2, and

FIG. 4 is a sectional view of an illustrative embodiment of an oil filter arrangement with a single ring seal that extends radially and axially.

### DETAILED DESCRIPTION OF EMBODIMENTS

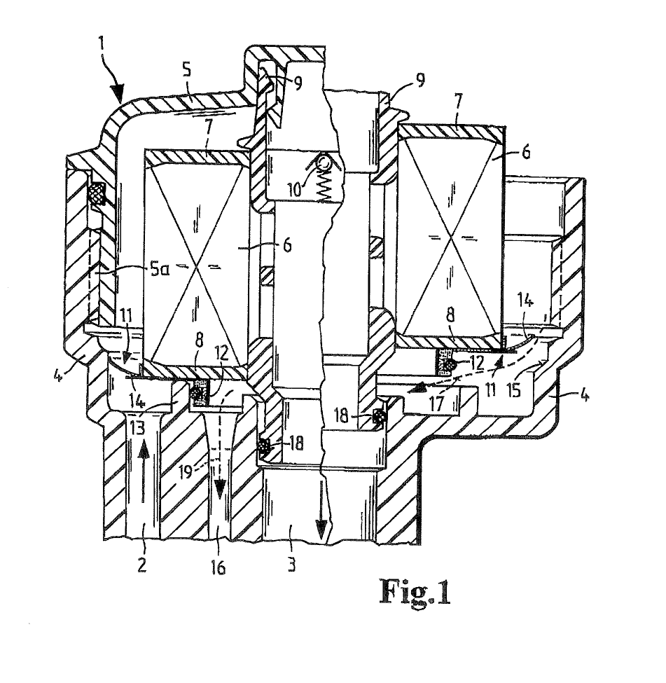

FIG. 1 schematically depicts a filter arrangement 1 for an internal combustion engine with an unfiltered liquid inlet 2, a filtered liquid outlet 3, a lower housing part 4, and a housing cover 5. Filter arrangement 1 comprises a filter element 6 that is normally formed by a zigzag-shaped folded (i.e. pleated) filter paper, an upper end disk 7, and a lower end disk 8. In the left part of the figure, filter element 6 is shown inside the closed housing 4, 5. In the right part of the figure, the filter arrangement is shown with the housing open and the filter element 6 already partly withdrawn in the axial direction.

As shown in FIG. 1, housing cover 5 has a center tube 9, which is attached to housing cover 5 by a snap-on connection. Center tube 9 further comprises a pressure relief valve 10 having the aforementioned prior art design. The housing cover 5 in its mounted state is connected with the lower housing part 4 in liquid-tight manner through a threaded joint 5a.

In this illustrative embodiment, filter element 6 is provided with a plastic or elastomer plate 11 on the lower end disk 8, by means of which a first seal can be realized on an axial extension 13 of housing 4 via an O-ring 12. This elastomer plate 11 is, for instance, glued to the lower end disk 8 or is attached to the end disk in a two-component molding process and has a membrane-like radial extension 14, which in principle can be used to realize a one-piece anti-back flow block or non-return valve. The lower end disk 8, with extension 14 on elastomer plate 11, fits in its mounted state with its edge radially against the inner wall of housing 4, as shown on the left side of the figure, and thereby forms the return-flow block or check valve. In other words, it prevents the unfiltered oil located in the unfiltered liquid area from flowing back into the unfiltered liquid inlet 2 when the engine is shut down.

The cross section on the right side of FIG. 1 shows the arrangement with the filter element 6 partially lifted axially out of the housing. Here, in a modification of the diagram shown on the left, an extension 15 is designed to support the membrane-like radial extension 14 in such a way that it sealingly contacts the housing wall 4. As the filter element 6 is being axially withdrawn, the first seal 12 is thereby initially released to enable the unfiltered liquid from inlet 2 to flow to a return flow channel 16, as indicated by arrow 17. As the filter element 6 with center tube 9 continues to be axially withdrawn, a second seal 18 is released to enable filtered liquid to flow back as indicated by arrow 19.

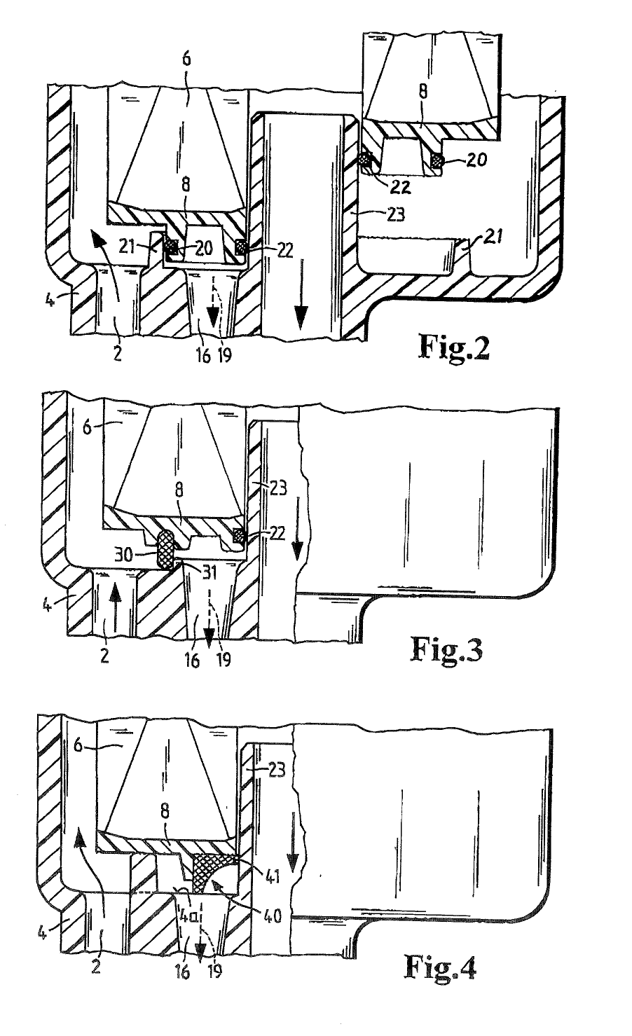

According to an alternative embodiment shown in FIG. 2, the first seal is formed by an axial projection 21 against which the first seal member 20 rests. This extension 21 is located in housing 4 between the inlet 2 for the liquid to be filtered and the return flow channel 16. The second seal is formed by contact between a sealing ring 22 and a standpipe 23, which is firmly anchored together with the housing 4. Due to the greater length of standpipe 23 compared to projection 21, when the filter cartridge is withdrawn from the filter housing, the first seal 20 will be released first while the second seal 22 maintains sealing contact for a time as shown on the right side of FIG. 2.

In the further alternative embodiment shown in FIG. 3, an axially extending first sealing ring 30 is formed. This sealing ring 30 fits against an axially extending projection 31 inside housing 4 between inlet 2 for the liquid to be filtered and return flow channel 16. As the filter cartridge 6 is withdrawn from the housing, sealing ring 30 disengages from projection 31 to release the first seal while contact is maintained between sealing ring 22 and standpipe 23 until sealing ring 22 is lifted above the standpipe to release the second seal.

Further, in accordance with another alternative embodiment shown in FIG. 4, the first seal 40 is formed such that the seal is axially located between the filter element 6 and the bottom 4a of housing 4. This seal 40 also extends with a radial extension 41 to the axially extending housing wall or to the central standpipe 23.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A filter arrangement for a liquid comprising a filter element, which during installation in the filter arrangement is axially inserted into a filter housing, wherein after installation the filter element seals a back flow device at least for the liquid to be filtered with at least one seal in front of a return flow channel, wherein the back flow device is configured in such a way that when the filter element is being axially withdrawn from the housing, a first seal is initially released to enable return flow of unfiltered liquid, and as the withdrawal of the filter element continues, a second seal is released to enable return flow of filtered liquid.

2. A filter arrangement according to claim 1, wherein the first seal is arranged on the filter element in such a way that it fits sealingly against a housing wall within a predefined axial range of motion and wherein the second seal is arranged on the filter element in such a way that it fits sealingly against an axially extending housing wall within a predefined range of motion, wherein the range of motion for the second seal is longer than the range of motion of the first seal.

3. A filter arrangement according to claim 2, wherein the first range of motion is defined by an axial projection against which the first seal fits within the housing between an inlet for the liquid to be filtered and the return flow channel.

4. A filter arrangement according to claim 2, wherein the first range of motion is defined by a first seal ring that fits against an axially extending projection within the housing between an inlet for the liquid to be filtered and the return flow channel.

5. A filter arrangement according to claim 2, wherein the first range of motion is defined by a seal member located axially between the filter element and a housing floor, and wherein said seal member extends radially to said axially extending housing wall to define the second range of motion.

6. A filter arrangement according to claim 2, wherein the first seal extends radially outwardly beyond a radial edge of the filter element to form a membrane surface in front of an inlet for unfiltered liquid, so that back flow of the unfiltered liquid is partially blocked.

7. A filter arrangment according to claim 6, wherein said membrane surface cooperates with a stop surface on the housing to partially block back flow of the unfiltered liquid.

8. A filter arrangement according to claim 1, wherein the liquid to be filtered is a fuel or a lubricant for an internal combustion engine of a motor vehicle.
